(19) United States
(12) Patent Application Publication
(10) Pub. No.: US 2018/0308029 A1
(43) Pub. Date: Oct. 25, 2018

(54) Method And Arrangement For Allocating A Workspace To Employees In An Office Building

(71) Applicant: Siemens Schweiz AG, Zurich (CH)

(72) Inventors: Peter Löffler, Zug (CH); Oliver Zechlin, Zug (CH)

(73) Assignee: Siemens Schweiz AG, Zürich (CH)

(21) Appl. No.: 15/956,024

(22) Filed: Apr. 18, 2018

(30) Foreign Application Priority Data
Apr. 20, 2017 (DE) 10 2017 206 685.7

(51) Int. Cl. G06Q 10/06; H04L 29/08; H04W 4/024; H04W 4/12

(52) U.S. Cl. CPC G06Q 10/06313; H04L 67/306; G05B 15/02; H04W 4/12; H04W 4/024

(57) ABSTRACT

The present disclosure relates to allocation of resources. For example, a method for allocating a workspace to a set of employees in an office building may include: storing infrastructure data of the office building in a building management system; storing work profiles of the employees in an employee database, wherein the respective work profiles include comfort preferences of the respective employees; accessing planned work activities with a start time and end time stored in an electronic calendar for each employee; and determining and allocating a workspace to a respective employee on the basis of the infrastructure data, the respective work profile, and the respective planned activities.

### CROSS-REFERENCE TO RELATED APPLICATIONS

This application claims priority to DE Application No. 10 2017 206 685.7 filed Apr. 20, 2017, the contents of which are hereby incorporated by reference in their entirety.

### TECHNICAL FIELD

The present disclosure relates to allocation of resources. Various embodiments may include methods and arrangements for allocating a workspace to employees in an office building.

### BACKGROUND

In buildings with office workspace there is increasing evidence of a trend toward the “open office”, with a requirement for optimizing space use. With this trend comes a transition from the traditional fixed workspace location which is usually stored in employee directories to open office areas in which the employees reselect a suitable free desk for themselves every day.

“Open office” concepts, on the one hand, enable optimization of the requirement for office spaces for an employer, but, on the other hand, an employee must adapt every day to a different workspace which is not always appropriate or optimal for respective work or activities to be carried out. Due to the dynamically changing seating allocation and neighboring colleague allocation in open office environments, employees lack the facility to create pleasant individual work areas for themselves, since the occupancy configurations and therefore the likes and preferences of the employees located there change dynamically and daily.

### SUMMARY

The teachings of the present disclosure may be embodied in methods and arrangements for allocating a workspace to employees in an office building, wherein the workspace is appropriate for respective employee preferences and respective work activities. For example, a method for allocating a workspace (AP1-AP8) to employees (P) in an office building (BG), may include: storing infrastructure data (ID) of the office building (BG) in a building management system (GMS); storing work profiles (AP) of the employees (P) are stored in an employee database (MDB), wherein the respective work profiles (AP) comprise comfort preferences of the respective employees (P); storing planned work activities with a start time and end time in each case in an electronic calendar (EK) for each employee (P); and allocating an appropriate workspace (AP1-AP8) to a respective employee (P) on the basis of the infrastructure data (ID), the respective work profile (AP), and the respective planned activities.

In some embodiments, the allocation of the appropriate or suitable workspace (AP1-AP8) is communicated to the employee (P) on a mobile communication terminal device (MG).

In some embodiments, the allocation of the appropriate workspace (AP1-AP8) is indicated to the employee (P) on a screen (AZ).

In some embodiments, the performed allocation of the workspace (AP1-AP8) is acknowledged by the respective employee (P).

In some embodiments, the allocated workspace (AP1-AP8) is evaluated by the employee (P) and the workspace (AP1-AP8) is also allocated on the basis of the evaluation.

In some embodiments, the employee (P) is guided via an indoor positioning system (IPS) to the allocated workspace (AP1-AP8).

As another example, an arrangement for allocating a workspace (AP1-AP8) to employees (P) in an office building (BG), may comprise: (GMS) a memory unit (SP), in particular of a building management system, wherein infrastructure data (ID) of the office building (BG) are stored in the memory unit (SP); an employee database (MDB) in which work profiles (AP) of the employees (P) are stored, wherein the respective work profiles (AP) comprise activity profiles and comfort preferences of the respective employees (P); an electronic calendar (EK) in which planned work activities with a start time and end time are stored in each case for a respective employee (P); and a data processing unit (DVE) which is configured to define the allocation of an appropriate workspace (AP1-AP8) for an employee (P) on the basis of the infrastructure data (ID), the respective profile (AP) and the respective planned activities.

In some embodiments, there is a mobile communication terminal device (MG) and/or an output unit (AZ) on which the allocation of the workspace (AP1-AP8) is communicable to the employee (P).

In some embodiments, there is an evaluation unit (BE) which is configured to receive and evaluate an evaluation of the allocated workspace (AP1-AP8) by the employee (P), wherein the workspace (AP1-AP8) is also allocated on the basis of the evaluation.

In some embodiments, there is an indoor positioning system (IPS) which is configured to guide the employee (P) to the allocated workspace (AP1-AP8) through corresponding information on the mobile communication terminal device (MG).

In some embodiments, the infrastructure data (ID) of the office building (BG) are stored in a corresponding building information model (BIM).

### BRIEF DESCRIPTION OF THE DRAWINGS

The teachings of the present disclosure and various embodiments of the teachings are explained by way of example with reference to the following figures, in which:

FIG. 1 shows an example of an arrangement for allocating a workspace to employees in an office building, and

FIG. 2 shows an example of a flow diagram for a method for allocating a workspace to employees in an office building.

### DETAILED DESCRIPTION

Some embodiments include a method for allocating a workspace to employees in an office building, wherein infrastructure data of the office building are stored in a building management system; wherein work profiles of the employees are stored in an employee database, wherein the respective profiles comprise comfort preferences of the respective employees; wherein planned work activities with a start time and end time are stored in each case in an electronic calendar (e.g. Outlook) for each employee; wherein a suitable workspace is allocated to a respective employee on the basis of the infrastructure data, the respective profile and the respective planned activities. The method may use building or room characteristics to allocate a suitable seating space or workspace or a compatible area to users (e.g. employees) depending on their personal preferences (comfort preferences, such as temperature, lighting, ambient sound level, and/or their daily diary (e.g. planned activities). A building thus becomes more intelligent and is also perceived by employees as an intelligent building. The people located or working therein are ideally more motivated, more productive and more satisfied. This is expected to result in an increase in the work performance and work efficiency of the employees.

The building premises are also utilized more effectively, e.g. through an improvement in the utilization of the premises or the occupancy of the workspaces. The facility furthermore exists to work with the existing status of a building, i.e. temperature differences due to e.g. outdated insulation, windows, etc. are used by employees with corresponding temperature preferences. In respect of a workspace or a work area (comprising a plurality of workspaces), a workspace is allocated to employees with an identical or sufficiently similar profile (activity profile, comfort preferences). This increases, inter alia, the energy efficiency at the workspace or the work area, since no changes or adjustments (e.g. to the temperature or lighting) by the allocated employees are required at the workspace. A similar profile can be defined e.g. on the basis of fuzzy logic. An energy saving is furthermore achieved in the building since unallocated workspaces or areas do not have to be heated or cleaned.

In some embodiments, the allocation of the appropriate or suitable workspace is communicated to the employee on a mobile communication terminal device (e.g. smartphone). An employee is thereby informed in a timely manner of his allocated workspace, e.g. through a notification via a messenger service (e.g. WhatsApp, Twitter). This notification may take place regularly at a predefined time.

In some embodiments, the allocation of the appropriate workspace is indicated to the employee on a screen. The screen may be located, for example, in the entrance area of the building, e.g. in a location which the employees must pass on the way to the workspace.

In some embodiments, the performed allocation of the workspace is acknowledged by the respective employee. As a result, the allocation system knows that the corresponding employee will be present, i.e. will occupy the allocated space. The allocation system can use this information to release or activate resources required at the workspace. This information can furthermore be used for energy management in the office.

In some embodiments, the allocated workspace is evaluated by the employee and the workspace is also allocated on the basis of the evaluation. The motivation, satisfaction and work performance of the employees are increased as a result.

In some embodiments, the employee is guided via an indoor positioning system to the allocated workspace. Employees are thereby guided directly to the allocated workspace. This may be helpful for new employees or for employees from other locations, as their locations may change frequently. Nowadays, indoor positioning systems (ibeacon, WLAN) typically form part of the infrastructure of buildings. The employee may be guided to the allocated workspace via a corresponding app on the Smartphone.

As another example, an arrangement for allocating a workspace to employees in an office building, may include:
a memory unit, e.g. of a building management system, wherein infrastructure data of the office building are stored in the memory unit;
an employee database in which work profiles of the employees are stored, wherein the respective work profiles comprise activity profiles and comfort preferences of the respective employees;
an electronic calendar (e.g. Outlook) in which planned work activities with a start time and end time are stored in each case for a respective employee; and
a data processing unit configured to define the allocation of a suitable workspace for an employee on the basis of the infrastructure data, the respective work profile and the respective planned activities. The arrangement may be be implemented or installed with means and infrastructure which are already present in any case in a building. The arrangement enables, inter alia, an increase in the work performance or work efficiency of the employees. The building premises are also utilized more effectively, e.g. through an improvement in the utilization of the premises or the occupancy of the workspaces.

In some embodiments, the arrangement comprises a mobile communication terminal device (e.g. Smartphone) and/or an output unit (e.g. a monitor at the building entrance) on which the allocation of the workspace is communicable to the employee. Nowadays, mobile communication terminal devices, such as Smartphones and tablet computers, are owned by employees, either in private ownership or as company devices. The mobile communication terminal devices are enabled to communicate with the arrangement or to present corresponding allocation information through corresponding software (e.g. through a download of a corresponding app). Nowadays, output units, such as monitors or electronic display boards, are present in office buildings (particularly in the entrance area or in or by elevators) or are easily retrofittable.

In some embodiments, the arrangement comprises an evaluation unit configured to receive and evaluate an evaluation of the allocated workspace by the employee, wherein the workspace is also allocated on the basis of the evaluation. As a result, the arrangement is an adaptive system, e.g. based on neural networks or fuzzy logic. Employee satisfaction and work efficiency of the employees are thereby further increased, since inappropriate allocations (allocations with which employees are not satisfied) are avoided or reduced.

In some embodiments, the arrangement comprises an indoor positioning system which is configured to guide the employee to the allocated workspace through corresponding information on the mobile communication terminal device. Nowadays, indoor positioning systems (e.g. Bluetooth ibeacon or WLAN) form part of the infrastructure in office buildings or the systems can easily be retrofitted. The targeted guidance of an employee to an allocated workspace increases work efficiency, since an employee wastes no time searching for the workspace.

In some embodiments, the infrastructure data of the office building are stored in a corresponding building information model (BIM). The building information model (BIM), e.g. based on IFC (“Industry Foundation Classes”), comprises a building plan and the office plans in which the installed infrastructure and the respective physical division of the office spaces are stored. The building information model may form part of the building management system. The building information model (BIM) of the corresponding building is stored e.g. in a memory (e.g. flash memory) of the building automation system (building management system), or in a database to which the building automation system or the data processing unit of the arrangement has access. The storage of the infrastructure data in a building information model (BIM) ensures that the database is always up-to-date for the allocation of the employees to a workspace.

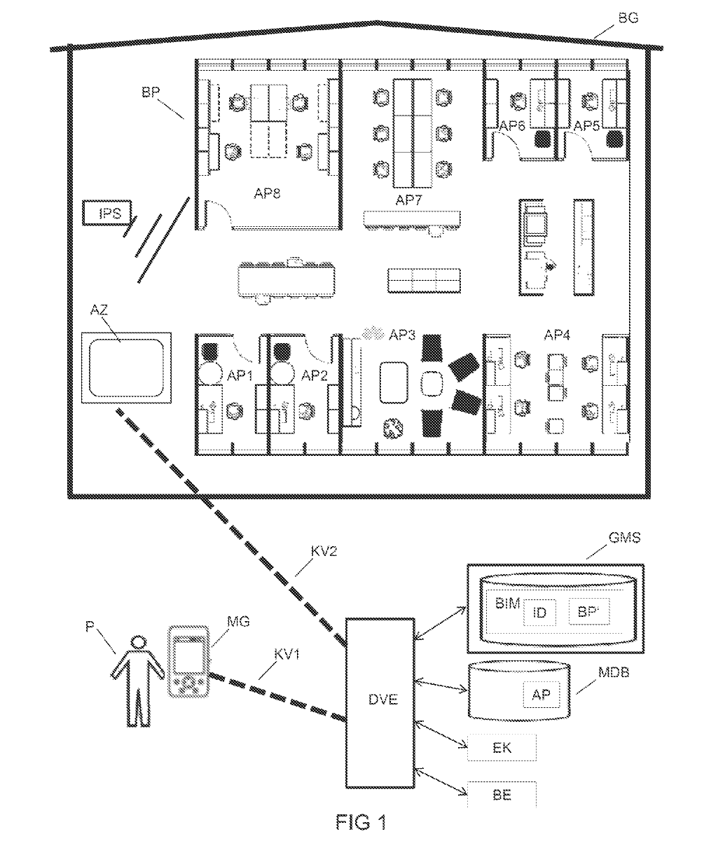

FIG. 1 shows an example of an arrangement for allocating a workspace AP1-AP8 to employees P in an office building BG. The arrangement comprises:
a memory unit SP, in particular of a building management system GMS, wherein infrastructure data ID (e.g. plans with location information for facilities installed in the office building BG) of the office building BG are stored in the memory unit SP;
an employee database MDB in which work profiles AP of the employees are stored, wherein the respective work profiles AP comprise activity profiles (e.g. assignment of an employee to projects, job description, deadlines, submission dates) and comfort preferences (e.g. preferred temperature at the workspace, noise tolerance, preferred lighting) of the respective employees P;
an electronic calendar EK (e.g. Outlook) in which planned work activities with a start time and end time are stored in each case for a respective employee P;
a data processing unit DVE which is configured to define the allocation of an appropriate or suitable workspace AP1-AP8 for an employee P on the basis of the infrastructure data ID, the respective work profile AP and the respective planned activities.

The workspaces AP1-AP8 may be individual workspaces or work areas. The workspaces AP1-AP8 may be equipped in each case with an infrastructure (corresponding software and/or hardware) corresponding to the respective activity profiles and respective work tasks. An appropriate or suitable workspace AP1-AP8 is, e.g., equipped with corresponding infrastructure (hardware, software, communication mechanisms) to meet the current activity requirement of the employee. An adequate or suitable workspace AP1-AP8 may be located in an environment that is pleasant for the respective employee (e.g. in terms of lighting, ambient noise level).

In some embodiments, the arrangement comprises a mobile communication terminal device MG (e.g. Smartphone, tablet computer) and/or an output unit AZ (e.g. monitor, display at the building entrance) on which the allocation of the workspace AP1-AP8 is communicable to the employees P. The employees P can thereby be notified very quickly of allocated workspaces AP1-AP8.

In some embodiments, the arrangement comprises an evaluation unit BE configured to receive and evaluate an evaluation of the allocated workspace AP1-AP8 by the employee P, wherein the workspace is also allocated on the basis of the evaluation. The evaluation unit BE is implemented e.g. through corresponding hardware (processor) and software, e.g. based on neural networks or fuzzy logic. Employee satisfaction and the work efficiency of the employees are thereby increased, since inappropriate allocations (allocations with which employees are not satisfied) are avoided or reduced.

In some embodiments, the arrangement comprises an indoor positioning system IPS (e.g. ibeacons, WLAN) configured to guide the employee P to the allocated workspace or work area AP1-AP8 through corresponding information on the mobile communication terminal device MG. Indoor positioning systems IPS, e.g. ibeacons or WLAN, form part of the normal infrastructure of a building BG, or can easily be retrofitted. An indoor navigation system which guides the employees P to the allocated workspace AP1-AP8 through targeted information on the mobile communication terminal device MG can therefore easily be created by means of the indoor positioning system IPS.

The infrastructure data ID of the office building BG may be stored in a corresponding building information model BIM. The infrastructure data ID comprise, inter alia, information relating to installed facilities. The building information model BIM advantageously also comprises the office plans BP, BP′, i.e. information relating to office spaces located in the building BG. The storage of the infrastructure data ID and the office plans BP′ ensures, inter alia, that the office plan BP′ represented in the building information model BIM corresponds to the physical (real) office plan BP. It is thereby ensured that the allocations of the workspaces AP1-AP8 are always based on the current conditions.

The IT and communication infrastructure of the arrangement can be implemented by means of conventional computers (laptop, PC, workstation) with corresponding processors, storage media and communication mechanisms, and corresponding software programs. The communication connections KV1, KV2 can be implemented e.g. by means of radio links or short-range communication (NFC, Near Field Communication, e.g. Bluetooth).

Certain areas, premises, or rooms in a building BG have persistent characteristics. These may differ from one another in terms of the following features: ambient noise level, ambient temperature, oxygen content, relative humidity, pollutants, air conditioning system yes/no, solar irradiation, natural light, light temperature, or brightness. Building management systems GMS allocated to the building BG manage information or have access to other systems which hold this information, such as building user preference profiles and/or building user presence information and/or the diary of the users (e.g. in the Outlook calendar EK).

A corresponding area or corresponding premises may be booked, allocated or proposed for employees P on the basis of their stored profiles, current preferences, and/or consideration of planned daily activities. This may also involve a plurality of locations AP1-AP8, suitable for the respective diary, per day. The current room can optionally be stored for the employee P in the employee database in order to locate him during the day.

If the system or the arrangement which carries out the seating planning has sight of the calendar EK and therefore the upcoming activities of the employees P, an x-day planning can also be carried out in advance. The system or the arrangement draws up a “seating plan” on the basis of the available information. Internal building resources can utilized be more effectively as a result.

### Example

If a large number of people happen to be absent (e.g. due to business trips, sickness or leave), the planning can be devised in such a way that certain “open office” building areas are not released for this time period. The operating expenses (OPEX) of the building can be reduced through the temporary exclusion of these areas, since e.g. no cleaning staff need to be employed there. Power or energy costs can also be optimized in this way, since a large area does not have to be kept “operational” for a minimal number of people.

An ad hoc planning is also possible on the basis of indoor positioning: If a known person P (e.g. recognition by badge (employee ID), biometric features, communication terminal device) enters a certain area (e.g. foyer), recommended areas or workspaces AP1-AP8 are indicated through notification (e.g. push notification on the mobile communication terminal device MG). This recommendation can be accepted (reserved or booked), or a different space can be selected. For persons who do not allow the system to have sight of their digital diary or their electronic calendar EK for reasons of data privacy, a manual area or space selection process is possible. A space selection can be activated, e.g. by means of touchscreen devices installed in the foyer, depending on the preferences (e.g. window seat, quiet area, etc.). An area, a space or a room can furthermore be actively proposed in the area optimization by the system or the arrangement, possibly with a “reward system” if this selection is accepted.

### Examples/Scenarios

If the system or the arrangement recognizes upcoming phone calls, Skype sessions, live meetings, or similar (remote) conferences on the basis of the calendar entries, a suitable area or premises corresponding thereto are booked, allocated or proposed for the employee P. In this case, individual rooms would be appropriate in order to avoid disturbing other persons present.
If it is stored in the profile AP that a room temperature of 22° C. is preferred, an area or workspace AP1-AP8 of this type may be booked, allocated, or proposed in the normal daily routine.
If the electronic calendar EK indicates that research activities are upcoming for an employee P, a quiet area may be booked, allocated, or proposed.
If a space, room, or area proposal is accepted, the employee P can optionally be guided to the corresponding space AP1-AP8 by means of the indoor positioning IPS. Similarly, a rights profile necessary for the room or the area can optionally be activated for the employee P. This may, inter alia, be the authorization for office equipment, room operating elements or access control.
A feedback system is optionally incorporated into the arrangement to refine the profiling of the building users P. With this system, the users P can evaluate the spaces, areas, or seats allocated to them (e.g. “too hot”, “too noisy”, “optimal”). A further profile optimization for the employees P can also be carried out by the system through data analysis (e.g. usually sits near persons x, y, z; finds areas a, b, c particularly good).

Building management systems GMS allocated to the building BG can be installed locally in the building or on the campus, or remotely in a cloud application. Various embodiments may be particularly useful in very modern buildings BG with e.g. low-temperature heating. In these buildings BG, an employee P has no or hardly any facilities to influence a room control. A room control would only be active, if at all, with a long delay (several hours), since the control systems usually respond very slowly.

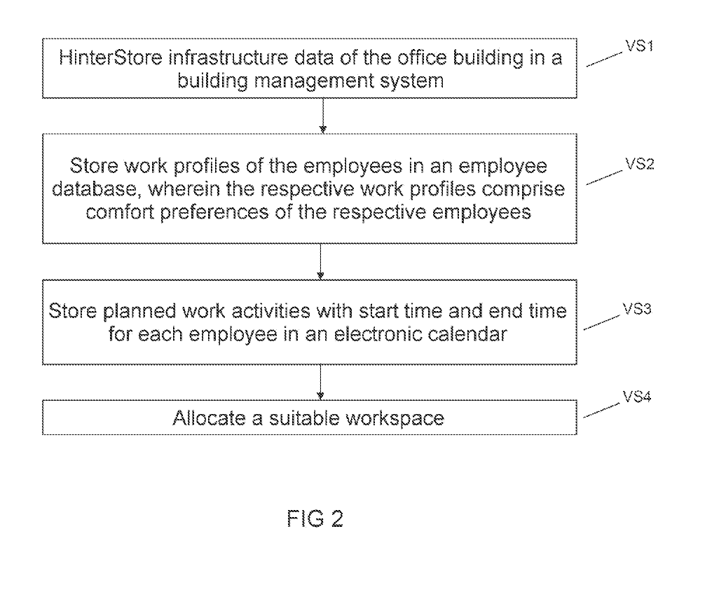

FIG. 2 shows an example of a flow diagram for a method for allocating a workspace to employees in an office building,
(VS1) wherein infrastructure data of the office building are stored in a building management system;
(VS2) wherein work profiles of the employees are stored in an employee database, wherein the respective work profiles comprise comfort preferences of the respective employees;
(VS3) wherein planned work activities with a start time and end time are stored in each case in an electronic calendar (e.g. Outlook) for each employee;
(VS4) wherein a suitable workspace is allocated to a respective employee on the basis of the infrastructure data, the respective work profile and the respective planned activities. The method enables, inter alia, an increase in the work performance or work efficiency of the employees.

The building premises are also utilized more effectively, e.g. through an improvement in the utilization of the premises or the occupancy of the workspaces. The method can be implemented by means of correspondingly set up or configured hardware and software components, e.g. computers with corresponding memory, processor, input/output, communication and software equipment (e.g. office applications (Office package, databases)).

Comfort preferences may comprise not only temperature and light, but also noise level and ambient noise. Entries in the electronic calendar (e.g. Outlook) comprise the start/end time of a planned activity, but may also include a context level or context information (semantics), i.e. the allocation system (or the allocation arrangement) recognizes from the appointments which type of activity is upcoming and how this activity may influence the surrounding area. If, for example, a teleconference is due to be held, this will have a disturbing effect on colleagues requiring quiet. This information may be taken into account in the allocation.

A “clustering” of like-minded persons is also possible. Employees, for example, who prefer a cooler temperature or who like to work by an open window are grouped together in an area. This reduces friction among employees and therefore also increases, inter alia, work efficiency.

The allocation of the appropriate or suitable workspace may be communicated to the employee on a mobile communication terminal device (e.g. Smartphone, tablet computer). The allocation of the appropriate workspace can also or simultaneously be indicated to the employee on a screen (e.g. in the entrance area of the building or in the vicinity of elevators). A performed allocation of the workspace may be acknowledged by the respective employee. The allocation system is thereby notified that an employee has accepted the allocation.

The allocated workspace may be evaluated by the employee. As a result, the allocation system knows whether the employee is satisfied with the allocated workspace or the allocated area in the building and can take this information into account for further allocations for specific employees. The workspace may be allocated on the basis of a previous evaluation.

The employee may be guided to the allocated workspace via an indoor positioning system which in each case transmits corresponding navigation information to the mobile communication terminal device (e.g. Smartphone) of the respective employee. An employee is thereby guided to the allocated workspace effectively and without delay.

### REFERENCE NUMBER LIST

BG Office building
DVE Data processing unit
SP Memory
ID Infrastructure data
BIM Building information model
MDB Employee database
AP Work profiles
P Employee
MG Mobile device
KV1-KV2 Communication connection
EK Electronic calendar
BE Evaluation unit
IPS Positioning system
AZ Display device
AP1-AP8 Workspace
VS1-VS4 Method step
GMS Building management system
BP, BP′ Office plan

1. A method for allocating a workspace to a set of employees in an office building, the method comprising:
storing infrastructure data of the office building in a building management system;
storing work profiles of the employees in an employee database, wherein the respective work profiles include comfort preferences of the respective employees;
accessing planned work activities with a start time and end time stored in an electronic calendar for each employee; and
determining and allocating a workspace to a respective employee on the basis of the infrastructure data, the respective work profile, and the respective planned activities.

2. The method as claimed in claim 1, further comprising communicating the allocation of the workspace to the respective employee on a mobile communication terminal device.

3. The method as claimed in claim 1, further comprising indicating the allocation of the workspace to the respective employee on a screen.

4. The method as claimed in claim 1, further comprising accepting an acknowledgement of the allocation of the workspace from the respective employee.

5. The method as claimed in claim 1, further comprising accepting an evaluation of the workspace from the employee and using the evaluation for future allocation procedures.

6. The method as claimed in claim 1, further comprising guiding the respective employee via an indoor positioning system to the allocated workspace.

7. An arrangement for allocating a workspace to a set of employees in an office building, the arrangement comprising:
a memory unit associated with a building management system, wherein infrastructure data of the office building are stored in the memory unit;
an employee database storing work profiles of the set of employees, wherein the respective work profiles include activity profiles and comfort preferences of the respective employees;
an electronic calendar storing planned work activities with a start time and end time for the respective employees; and
a data processing unit determining an allocation of an appropriate workspace for each employee on the basis of the infrastructure data, the respective profile, and the respective planned activities.

8. The arrangement as claimed in claim 7, further comprising a mobile communication terminal device and/or an output unit communicating the allocation of the workspace to the respective employees.

9. The arrangement as claimed in claim 7, further comprising an evaluation unit configured to receive and evaluate an evaluation of the allocated workspace from the employee, wherein future allocation of the workspace is made on the basis of the evaluation.

10. The arrangement as claimed in claim 7, further comprising an indoor positioning system configured to guide the respective employees to allocated workspaces through corresponding information on the mobile communication terminal device.

11. The arrangement as claimed in claim 7, wherein the infrastructure data of the office building are stored in a corresponding building information model.
